(19) United States
(12) Patent Application Publication
(10) Pub. No.: US 2009/0101775 A1
(43) Pub. Date: Apr. 23, 2009

(54) MOUNTING ASSEMBLY OF DASHBOARD MODULE

(76) Inventor: Joo Wha Kim, Suwon-si (KR)

Correspondence Address: MORGAN, LEWIS & BOCKIUS LLP (SF), One Market, Spear Street Tower, Suite 2800, San Francisco, CA, 94105, US

(21) Appl. No.: 12/104,928

(22) Filed: Apr. 17, 2008

(30) Foreign Application Priority Data
Oct. 22, 2007 (KR) 10-2007-0106196

(51) Int. Cl. G12B 9/00

(52) U.S. Cl. 248/205.1

(57) ABSTRACT

A mounting assembly for mounting a dashboard module to a body panel of a vehicle is disclosed. The dashboard module includes a blower unit, a cowl cross member, and a dashboard. At least one side bracket is provided on the cowl cross member, and spaced apart from the body panel by a gap. A nut assembly is mounted to the side bracket, and includes a guide block defining a hole. A bolt extends through the body panel and the side bracket, and is screwed into the hole of the guide block. The guide block is configured such that, upon screwing the bolt in a first direction into the hole, the guide block moves in an opposite direction along the bolt, into the gap.

### CROSS-REFERENCE TO RELATED APPLICATIONS

This application claims priority to Korean Application No. 10-2007-0106196, filed on Oct. 22, 2007, the disclosure of which is incorporated herein by reference.

### BACKGROUND OF THE INVENTION

1. Field of the Invention

The present invention relates to a mounting assembly of a dashboard module.

2. Description of the Related Art

Traditionally, before a dashboard is mounted in a vehicle, a blower unit for blowing air from the heating and air conditioning system is mounted to the body panel, and then a cowl cross member is mounted. Finally, the dashboard is mounted to the body panel.

However, his process of mounting the dashboard requires many workers in an assembly line and also results in delays in operation. Therefore, recently, the blower unit, the cowl cross member, and the dashboard are integrated into one dashboard module, which is mounted to the body panel as a single unit. The mounting hardware is assembled in a very limited space. The assembly process is therefore not efficient and takes a long process time.

The information disclosed in this Background of the Invention section is only for enhancement of understanding of the background of the invention and should not be taken as an acknowledgement or any form of suggestion that this information forms the prior art that is already known to a person skilled in the art.

### SUMMARY OF THE INVENTION

A mounting assembly for mounting a dashboard module to a body panel of a vehicle is disclosed. The dashboard module includes a blower unit, a cowl cross member, and a dashboard. At least one side bracket is provided on the cowl cross member, and spaced apart from the body panel by a gap. A nut assembly is mounted to the side bracket, and includes a guide block defining a hole. A bolt extends through the body panel and the side bracket, and is screwed into the hole of the guide block. The guide block is configured such that, upon screwing the bolt in a first direction into the hole, the guide block moves in an opposite direction along the bolt into the gap.

The nut assembly may also include a main body attached to the side bracket, defining a guide hole. The guide block may be movable within the guide hole. The guide hole may have threads on an inner surface thereof, and the guide block may have threads on an outer surface thereof.

### BRIEF DESCRIPTION OF THE DRAWINGS

The above and other features of the present invention will now be described in detail with reference to certain exemplary embodiments thereof, illustrated the accompanying drawings, which are given for purposes of illustration, and are not limitative of the present invention, and wherein:

FIGS. 1A and 1B are cross-sectional views illustrating a mounting assembly of a dashboard module according to an embodiment of the present invention;

FIG. 2 is an exploded perspective view illustrating an embodiment of the nut assembly according to the present invention; and

FIGS. 3A and 3B are perspective views illustrating the operation of the nut assembly of FIG. 2.

It should be understood that the appended drawings are not necessarily to scale, presenting a somewhat simplified representation of various preferred features illustrative of the basic principles of the invention. The specific design features of the embodiments as disclosed herein, including, for example, specific dimensions, orientations, locations, and shapes will be determined in part by the particular intended application and use environment.

In the figures, reference numbers refer to the same or equivalent parts throughout the several figures of the drawing.

### DETAILED DESCRIPTION OF PREFERRED EMBODIMENTS

Reference will now be made in detail to a preferred embodiment of the present invention, an example of which is illustrated in the accompanying drawings and described below. While the invention will be described in conjunction with an exemplary embodiment, it should be understood that the description is not intended to limit the invention to the exemplary embodiment. On the contrary, the invention is intended to cover not only the exemplary embodiment, but also various alternatives, modifications, equivalents and other embodiments, which may be included within the spirit and scope of the invention as defined by the appended claims.

Embodiments of the present invention provide a dashboard module including a blower unit a cowl cross member, and a dashboard, which are integrated with each other, and mounted to a body panel of a vehicle as a single unit.

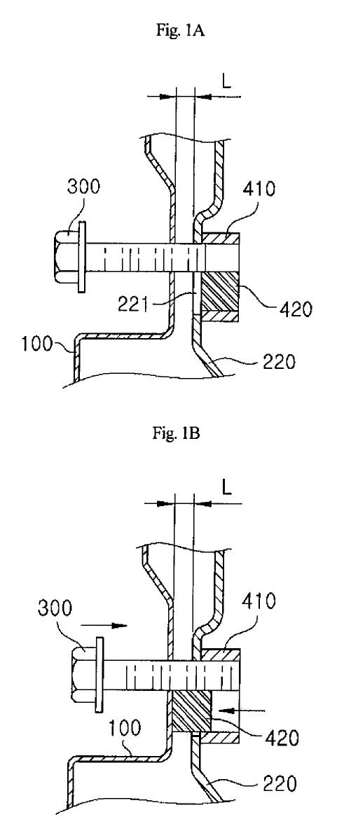

As shown in FIGS. 1A and 1B, side brackets 220 (only one of which is shown) are attached to both ends of a cowl cross member, and are attached to a body panel 100 of the vehicle.

Each side bracket 220 is spaced apart from the body panel 100 by a gap with width L, which facilitates mounting of the dashboard module. A nut assembly 400 of the present invention is attached to the inner side of the side bracket 220.

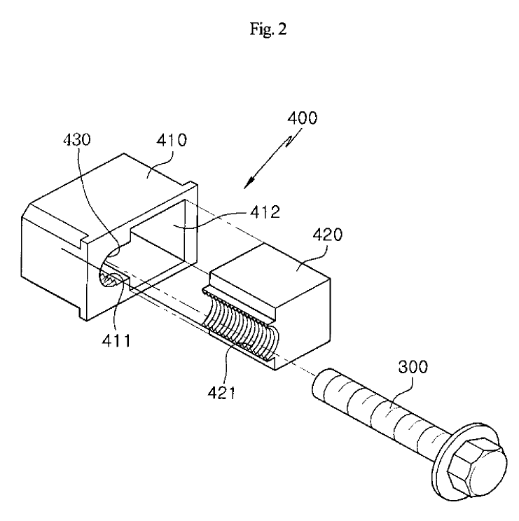

As shown in FIG. 2, the nut assembly 400 has a hole 430. A fastening bolt 300, which extends through the body panel 100 and the side bracket 200, is screwed into the hole 430. Accordingly, the side bracket 220 and the body panel 100 are coupled with each other to mount the dashboard module to the body panel 100.

The nut assembly 400 includes a main body 410 and a guide block 420. The main body 410 is attached to the inner surface of the side bracket 220. The central portion of the main body 410 has a guide hole 412 defined therein.

The guide block 420 is inserted into the guide hole 412 and is movable along the inner surface of the guide hole 412. First threads 411 are defined in part of the inner surface of the hole 430, and second threads 421 are defined in part of the outer surface of the guide block 420. The first threads 411 and the second threads 412 together define the threaded inner surface of the hole 430.

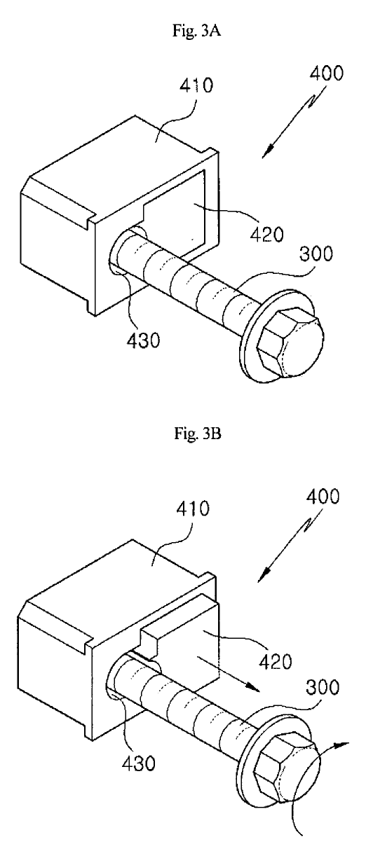

FIG. 3A shows the position where the fastening bolt 300 is screwed into the hole 430 in the nut assembly 400. When the fastening bolt 300 is turned, as shown in FIG. 3B, from the position of FIG. 3A, the guide block 420 moves along treads in the fastening bolt 300 in the direction opposite to the motion of the fastening bolt 300. That is, when the fastening bolt 300 is screwed in along the first threads 411, the guide block 420 moves backwards along the threads of the fastening bolt 300.

Returning to FIGS. 1A and 1B, as the fastening bolt 300 is screwed right in the Figures into the hole 430 in the nut assembly 400, the guide block 420 moves left in the Figures toward the body panel 100. In this fashion, the gap L between the body panel 100 and the side bracket 220 is eliminated when the side bracket 220 is mounted to the body panel 100.

That is, as shown in FIG. 1A, when the body panel 100 and the side bracket 220 are coupled with each other, they are spaced apart from each other by a distance L therebetween in order to facilitate mounting. The fastening bolt 300 is inserted through the body pane 100 and the side bracket 220, and is then screwed into the hole 430 of the nut assembly 400. Preferably, the side bracket 220 has a hole 221, through which the guide block 420 can move. As shown in FIG. 1B, when the fastening bolt 300 is turned, the guide block 420 moves through the hole 221 in the side bracket 220 to contact the body panel 100.

Accordingly, the gap L between the body panel 100 and the side bracket 220 is removed, thereby preventing vibration and noise.

In another embodiment, the second threads 421 extend only within a specific range in the longitudinal direction of the hole 430 of the nut assembly 400. Accordingly, it is possible to adjust the time at which or the distance that the guide block 420 moves in response to the screwing in of the fastening bolt 300.

While the present invention has been described with reference to particular illustrative embodiments and the accompanying drawings, it is not to be limited thereto, but will be defined by the appended claims. It is to be appreciated that those skilled in the art can substitute, change or modify the disclosed embodiments in various ways without departing from the scope and spirit of the present invention.

What is claimed is:

1. A mounting assembly for mounting a dashboard module to a body panel of a vehicle, the dashboard module comprising a blower unit, a cowl cross member, and a dashboard, the mounting assembly comprising:
at least one side bracket provided on the cowl cross member, and spaced apart from the body panel by a gap;
a nut assembly mounted to the side bracket, comprising a guide block defining a hole; and
a bolt configured to extend through the body panel and the side bracket, and to be screwed into the hole of the guide block;
wherein the guide block is configured such that, upon screwing the bolt in a first direction into the hole, the guide block moves in a second, substantially opposite direction along the bolt into the gap.

2. The mounting assembly according to claim 1, wherein the nut assembly further comprises a main body attached to the side bracket defining a guide hole; wherein the guide block is movable within the guide hole.

3. The mounting assembly according to claim 2, wherein the guide hole comprises first threads on an inner surface thereof, and the guide block comprises second threads on an outer surface thereof.
